(19) United States
(12) Patent Application Publication
(10) Pub. No.: US 2024/0279377 A1
(43) Pub. Date: Aug. 22, 2024

(54) PREPARATION OF MONODISPERSE POLYMER BEADS WITH ROOM TEMPERATURE INITIATION METHODS

(71) Applicant: BGI Shenzhen Co., Ltd., Shenzhen (CN)

(72) Inventors: Hongduan Huang, San Jose, CA (US); Handong Li, San Jose, CA (US)

(73) Assignee: BGI Shenzhen Co., Ltd., Shenzhen, GD (CN)

(21) Appl. No.: 18/554,059

(22) PCT Filed: Apr. 13, 2022
(86) PCT No.: PCT/CN2022/086539

§ 371 Date: Oct. 5, 2023

Related U.S. Application Data
(60) Provisional application No. 63/175,895, filed on Apr. 16, 2021.

(51) Int. Cl. C08F 257/02

(52) U.S. Cl. CPC C08F 257/02

(57) ABSTRACT

Techniques are described for preparing monodisperse polymer beads, such as using monosized seed particles, where the process of growing, polymerizing, or swelling the beads during preparation occurs at low, ambient, or room temperature. A variety of schemes are disclosed for growing, polymerizing, or swelling that avoid thermal initiation-based swelling. For example, photo polymerization, metal-free atom transfer radical polymerization, and redox polymerization schemes are disclosed. Additional features may be implemented in the monodisperse polymer beads, such as controlling bead density, controlling porous character, and inclusion of various chemical functionalities, including protected functionalities that can be activated or de-protected after preparation of the monodisperse polymer beads, such as during subsequent use.

### CROSS-REFERENCE TO RELATED APPLICATIONS

This application claims the benefit of and priority to U.S. Provisional Application No. 63/175,895, filed on Apr. 16, 2021, which is hereby incorporated by reference in its entirety.

### BACKGROUND

Magnetic polymer beads are extensively used in sequencing applications. Large magnetic polymer beads, especially beads having a diameter greater than 15 μm, have large surface area, which can be beneficial for single cell sequencing applications because they have a higher capacity for target nucleic acid sequences than smaller beads. Typical processes for preparing such magnetic polymer beads rely on thermal polymerization methods, which can require heating monomer droplets for long durations.

### SUMMARY

Seed-mediated swelling polymerization can be used for the preparation of large, monodisperse polymer beads. The use of high temperatures during preparation can be undesirable, since this can change the solubility of monomers and compromise the stability of large droplets, especially droplets having a diameter larger than 15 μm, leading to the breakage of emulsion and failure in polymerization. In addition, the monodispersity of the beads prepared under high temperature conditions can be poor, in some cases resulting in beads exhibiting a polydisperse character. The present disclosure provides techniques for preparing monodisperse polymer beads using a seed-mediated swelling polymerization process that avoids the use of high temperature polymerization, such as by employing alternative polymerization schemes, such as photo polymerization, metal-free atom transfer radical polymerization, or redox polymerization, allowing preparation of large size and highly monodisperse polymer beads.

In some examples, methods for preparing monodisperse polymer beads comprise mixing monosized polystyrene seed particles with an activating compound to generate activated seed particles; mixing the activated seed particles with a monomer compound and a crosslinking compound to generate monosized monomer drops; and subjecting the monosized monomer drops to polymerization conditions to generate monodisperse polymer beads, such as polymerization conditions that comprise a temperature of from 10° C. to 40° ° C. Optionally, mixing the monosized polystyrene seed particles with the activating compound occurs at a temperature of from 5° C. to 40° C. Optionally, mixing the activated seed particles with the monomer compound and the crosslinking compound occurs at a temperature of from 5° C. to 40° C. Optionally, the monosized polystyrene seed particles have a diameter selected from 0.1 μm to 20 μm. Optionally, the activating compound is present in an emulsion, such as an emulsion comprising the activating compound, water, and a surfactant. Optionally, mixing the monosized polystyrene seed particles with the activating compound comprises forming an aqueous emulsion of the activated seed particles.

The disclosed methods are useful for generating monodisperse polymer beads having a variety of different properties. For example, the monodisperse polymer beads may have a diameter of from 0.5 μm to 50 μm. Optionally, the monodisperse polymer beads may have a diameter of from 3 to 6 times a diameter of the monosized polystyrene seed particles. In some examples, the monodisperse polymer beads may exhibit a coefficient of variation (CV) of 5% or less. In some examples, the monodisperse polymer beads may exhibit one or more of the following characteristics, low or relatively low density, functionalization, or protected or latent functionality.

These and other embodiments, examples, and aspects of the invention along with many of advantages and features are described in more detail in conjunction with the text below and the attached figures.

### BRIEF DESCRIPTION OF THE DRAWINGS

FIG. 1 is schematic illustration of a seed-mediated swelling polymerization process according to some examples.

FIG. 2 provides a micrograph image of example polymeric beads prepared using 5 μm seeds, 1-chlorododecane, and 3% 2,2-dimethoxy-2-phenylacetophenone in a monomer mixture of glycidyl methacrylate and ethylene glycol dimethacrylate.

FIG. 3 provides a micrograph image of example polymeric beads prepared using 5 μm seeds, 1-chlorododecane, 3% 2-hydroxy-2-methylpropiophenone in a monomer mixture of glycidyl methacrylate and ethylene glycol dimethacrylate.

FIG. 4 provides a micrograph image of example polymeric beads prepared using 0.5 μm seeds, 1-chlorododecane, and 3% 2,2-dimethoxy-2-phenylacetophenone in a monomer mixture of glycidyl methacrylate and ethylene glycol dimethacrylate.

FIG. 5 provides a micrograph image of example polymeric beads prepared using 1 μm seeds, 1-chlorododecane, and 3% 2,2-dimethoxy-2-phenylacetophenone in a monomer mixture of glycidyl methacrylate and ethylene glycol dimethacrylate.

FIG. 6 provides a micrograph image of example polymeric beads prepared using 2 μm seeds, 1-chlorododecane, and 3% 2,2-dimethoxy-2-phenylacetophenone in a monomer mixture of glycidyl methacrylate and ethylene glycol dimethacrylate.

FIG. 7 provides a micrograph image of example polymeric beads prepared using 3 μm seeds, 1-chlorododecane, and 3% 2,2-dimethoxy-2-phenylacetophenone in a monomer mixture of glycidyl methacrylate and ethylene glycol dimethacrylate.

FIG. 8 provides a micrograph image of example polymeric beads prepared using 10 μm seeds, 1-chlorododecane, and 3% 2,2-dimethoxy-2-phenylacetophenone in a monomer mixture of glycidyl methacrylate and ethylene glycol dimethacrylate.

FIG. 9 provides a micrograph image of example polymeric beads prepared using 5 μm seeds, 1-chlorododecane, and 3% 2,2-dimethoxy-2-phenylacetophenone in a monomer mixture of glycidyl methacrylate (25%), hexyl methacrylate (75%), and ethylene glycol dimethacrylate.

FIG. 10 provides a micrograph image of example polymeric beads prepared using 5 μm seeds, 1-chlorododecane, and 3% 2,2-dimethoxy-2-phenylacetophenone in a monomer mixture of glycidyl methacrylate (5%), hexyl methacrylate (95%), and divinyl benzene.

### DETAILED DESCRIPTION OF SPECIFIC EMBODIMENTS

Aspects described herein relate to techniques for preparing monodisperse polymer beads, such as using monosized seed particles, where the process of growing, polymerizing, or swelling the beads during preparation occurs at low, ambient, or room temperature. A variety of schemes are disclosed for growing, polymerizing, or swelling that avoid thermal initiation-based swelling, which typically occurs under high temperature conditions. For example, photo polymerization, metal-free atom transfer radical polymerization, and redox polymerization schemes are disclosed. Additional features may be implemented in the monodisperse polymer beads, such as controlling bead density, controlling porous character, and inclusion of various chemical functionalities, including protected or latent functionalities that can be activated or de-protected after preparation of the monodisperse polymer beads, such as during subsequent use.

The monodisperse polymer beads can be advantageously used as a scaffold for preparation of magnetic polymer beads. Various techniques for magnetization of polymer beads can be used, such as those described in U.S. Pat. No. 4,774,265. In some examples, the monodisperse polymer beads can be magnetized by mixing with a solution of iron salts, or other ferromagnetic metals (e.g., Co, Ni, etc.), and changing the pH of the mixture to allow precipitation of iron or other ferromagnetic compounds, which can be uptaken by the polymer beads, resulting in the beads taking on a magnetic character, such as due to the presence of the iron or other ferromagnetic compounds on the surface and/or in the body of the polymer beads. The monodisperse polymer beads can be advantageously used by attaching biomolecules, such as nucleic acid sequences or bioconjugates, to the beads' surface. In some cases the magnetic monodisperse polymer beads can be used for nucleic acid separation or single cell sequencing.

In general the terms and phrases used herein have their art-recognized meaning, which can be found by reference to standard texts, journal references, and contexts known to those skilled in the art. Certain terms are defined herein to clarify their specific use in the context of the disclosure.

“Room temperature” refers to a range of temperatures found in typical indoor environments, such as a temperature of from about 15° C. to about 35° C., for example from 15.0° ° C. to 17.5° C., from 17.5° C. to 20.0° C., from 20.0° C. to 22.5° C., from 22.5° C. to 25.0° C., from 25.0° ° C. to 27.5° ° C., from 27.5° C. to 30.0° C., from 30.0° C. to 32.5° C., or from 32.5° C. to 35.0° C. Although not typical, room temperature can sometimes include temperatures as low as 10° C. or as high as 40° C. As used herein, the meaning of “ambient conditions” can include temperatures of about room temperature, relative humidity of from about 20% to about 100%, and barometric pressure of from about 975 millibar (mbar) to about 1050 mbar or atmospheric pressure. With reference to conditions where seed particles are used to generated monodisperse polymer beads in a mixture, room temperature conditions may indicate that heat is not applied to intentionally raise the temperature of the mixture to temperatures above room temperature, such as by an external heat source.

“Latex” refers to a dispersion of microparticles suspended or emulsified in a liquid, usually water or an aqueous mixture. The microparticles may be polymer microparticles, which may be referred to as polymer beads in some cases. In some examples, the term latex can also refer to precursor particles suspended or emulsified in a liquid, although such particles may not be polymerized, such as in the case of monomer drops.

“Monodisperse” or “monosize” refers to a distribution of particles that have sizes (e.g., diameter or other cross-sectional dimension) distributed about a single value, and contrasts with a polydisperse distribution of particles, in which the particle sizes can be distributed around several different values or can otherwise have an overall non-uniform or inconsistent distribution of sizes. Particles having a monodisperse distribution of sizes may be referred to as monodisperse particles or monodispersed particles. In some examples, monodisperse particles can have sizes distributed as a normal (Gaussian) distribution, and can be characterized by an average size and a metric indicating the amount of variation of around that average size, such as a standard deviation. In examples herein, reference to a diameter of monosized particles or monodisperse particles refers to the average size of the particles in the distribution. In some examples, polydispersed particles can be a mixture of particles of two monodisperse distributions having two or more different average sizes. In some cases, a coefficient of variation (CV) is used to characterize the dispersity of the distribution of particle sizes in a monodisperse distribution, which can correspond to a standard deviation of the particle sizes divided by the average size of particles in the distribution. In some examples, a monodisperse distribution may have a CV of 5% or less. In some examples, the CV may be 4% or less, 3% or less, 2% or less, or 1% or less. In some cases, monodisperse particles may have a size distribution with a small CV (e.g., less than 5%, 4%, 3%, 2%, or 1%) and be evaluated and calibrated according to a governmental or international standard (e.g., ISO, NIST, etc.).

In some examples, disclosed compositions or compounds are isolated or purified or used in isolated or purified form. Optionally, an isolated or purified compound is at least partially isolated or purified as would be understood in the art. In some examples, a disclosed composition or compound has a chemical purity of greater than 90%, optionally for some applications 95%, optionally for some applications 99%, optionally for some applications 99.9%, optionally for some applications 99.99%, or optionally for some applications 99.999% pure.

Some of the compounds disclosed herein may contain one or more ionizable groups. Ionizable groups include groups from which a proton can be removed (e.g., —COOH) or added (e.g., amines) or groups which can be quaternized (e.g., amines). All possible ionic forms of such molecules or salts thereof are intended to be included individually in the disclosure herein. With regard to salts of the compounds described herein, it will be appreciated that a wide variety of available counter-ions may be selected that are appropriate for preparation of salts for a given application. In specific applications, the selection of a given anion or cation for preparation of a salt can result in increased or decreased solubility of that salt.

As used herein, the terms “group” and “moiety” may refer to a functional group of a chemical compound. Groups of the disclosed compounds refer to an atom or a collection of atoms that are a part of the compound. Groups of the disclosed compounds may be attached to other atoms of the compound via one or more covalent bonds. In embodiments, the term “substituent” may be used interchangeably with the terms “group” and “moiety.”

The term “derivative” as used with reference to a base compound can refer to another compound related to or derived from the base compound, such as by making one or more substitutions of hydrogen atoms or other groups in the base compound. Examples of derivatives may include compounds where one or more substitutions to a base compound are made, such as substituting hydrogen atoms with halogens, hydroxyl groups, or small alkyl groups (e.g., methyl, ethyl), substituting alkyl chains for longer or shorter alkyl chains, substituting polarizable groups (e.g., hydroxy groups) with other polarizable groups (e.g., carboxylic acid groups), or the like.

### Seed-Mediated Swelling Polymerization

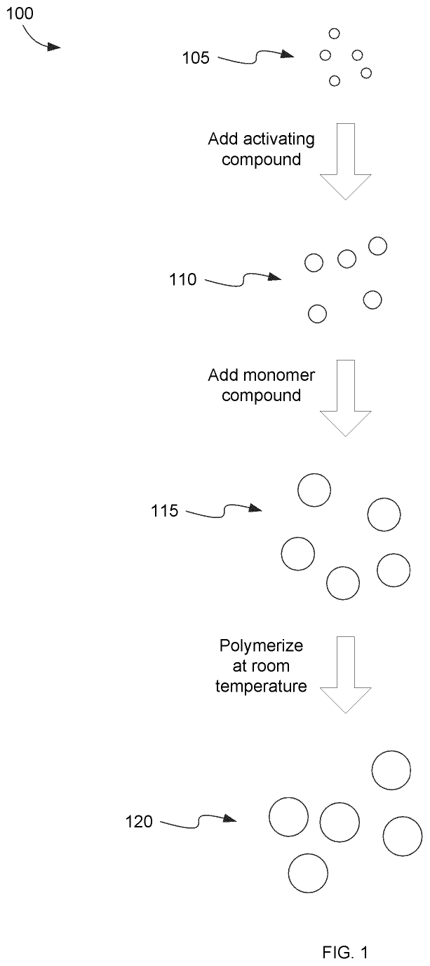

As noted above, aspects described herein are directed to processes of generating polymer beads using a seed-mediated swelling polymerization process. FIG. 1 provides a schematic overview of an example seed-mediated swelling polymerization process 100 according to aspects disclosed herein. As illustrated, seed particles 105, such as monosized polystyrene particles, are mixed with an activating compound, to form activated seed particles 110, such as in an emulsion. A monomer compound is then added to the mixture, at which point molecules of the monomer can be incorporated to the activated seed particles 110, to grow the particles and form larger particles referred to herein as monomer drops 115, which can also be monosized. The monomer drops 115 can be subjected to polymerization conditions to generate polymer beads 120, which can be monodisperse or substantially monodisperse. In some cases, crosslinking compounds, initiator compounds, and/or catalysts can be added to the mixture, such as with or at the same time as the seed particles 105 or activating compound, with or at the same time as the monomer compound, or after the monomer compound is added. It will be appreciated that the seed particles 105, the activated seed particles 110, the monomer drops 115, and the polymer beads 120 are not shown to scale in FIG. 1. Additional details about the various processes depicted in FIG. 1 are described below.

### Seed Activation

For the disclosed seed-mediated swelling polymerization processes, monosized seed particles can be used, such as monosized polystyrene seed particles. The seed particles can be highly monodisperse, such as having a CV of 5% or less, 4% or less, 3% or less, 2% or less, or 1% or less, for example. Monosized polystyrene particles are available from a variety of manufacturers and can be size verified according to governmental or international standards. In some examples, the monosized polystyrene particles can have a diameter selected from about 0.1 μm to about 20 μm, such as from 0.1 to 0.5 μm, from 0.5 μm to 1 μm, from 0.5 to 1.0 μm, from 1.0 μm to 1.5 μm, from 1.5 μm to 2.5 μm, from 2.5 μm to 3.0 μm, from 3.0 μm to 3.5 μm, from 3.5 μm to 4.0 μm, from 4.0 μm to 4.5 μm, from 4.5 μm to 5.0 μm, from 5 μm to 6 μm, from 6 μm to 7 μm, from 7 μm to 8 μm, from 8 μm to 9 μm, from 9 μm to 10 μm, from 10 μm to 12 μm, from 12 μm to 14 μm, from 14 μm to 16 μm, from 16 μm to 18 μm, or from 18 μm to 20 μm.

The monosized seed particles can be activated by mixing with an activating compound, which can, in some examples, result in molecules of the activating compound attaching or binding to a surface of the seed particles, preparing the particles for addition of monomers for a subsequent polymerization process. Such an activation process can be achieved, in some examples, by preparing an emulsion of the activating compound in water, adding the seed particles to the emulsion, and mixing. In other examples, the seed particles can be in an aqueous emulsion and the activating compound can be added to the emulsion and mixed. The duration of mixing can be from 1 to 36 hours, for example. Optionally, the activation process can occur at room temperature conditions, such as at a temperature of from 15° C. to 35° C. or any temperatures in between, such as a range of 18° C. to 27° C. Example activating compounds include, but are not limited to, dibutyl phthalate (DBP), bis-2(ethylhexyl) adipate (DEHA), or 1-chlorododecane (CD). In some examples, multiple different activating compounds can be used. Optionally, other components can be present in one or more of the emulsions, such as one or more polymerization catalysts, solvent, surfactants, or the like.

In some examples, the activating compound can be or comprise an initiator compound, which can be useful for initiation of the polymerization process in a later step. Optionally, an initiator compound may be a photoinitiator. Various different classes of initiator compounds can be used, such as initiator compounds containing a benzoyl group, a phenyl acetyl group, or comprising a Norish type I or type II photoinitiator, a redox initiator, or an atom transfer radical polymerization (ATRP) initiator. In some examples, an activating compound, which may be an initiator compound, may comprise a benzoin compound or a benzoin derivative, an acetophenone compound or an acetophenone derivative, a benzilketal compound, an α-hydroxyalkylphenone compound, an α-aminoalkylphenone compound, an O-acyl α-oximinoketone compound, an acylphosphine oxide compound, an acylphosphonate compound, a bromo compound, or a peroxide compound. Specific activating compounds, which may be initiator compounds, may include, but are not limited to, 2,2-dimethoxy-2-phenylacetophenone (DMPA), 2-hydroxy-2-methylpropiophenone (HMP), benzophenone, ethyl α-bromophenylacetate (EBBPA), methyl α-bromoisobutyrate, methyl 2-bromopropionate, 2-bromopropionitrile, diethyl 2-bromo-2-methylmalonate, 3-hydroxypropyl 2-bromo-2-methylpropanoate, or benzoyl peroxide (BPO).

### Monomer Droplet Growth

The activated seed particles can be grown into monomer drops by mixing with a monomer compound, which can, in some examples, result in molecules of the monomer compound becoming absorbed in the activated seed particles, and growing the particles to a larger size due to the addition of the monomer compound molecules. Such a process can be achieved, in some examples, by mixing an emulsion of the activated seed particles with the monomer compound. Optionally, the emulsion or the monomer compound can be mixed with other components, such as one or more initiator compounds, catalysts, crosslinking compounds, solvents, surfactants, or the like. The duration of the mixing can be from 1 to 24 hours, for example. Optionally, the monomer droplet growth process can occur at room temperature conditions, such as at a temperature of from 15° C. to 35° C.

A variety of different monomer classes and monomer compounds are useful with the disclosed methods. For example, useful monomer compounds include, but are not limited to, vinyl monomers, acrylate monomers, methacrylate monomers, methacrylamide compounds, acrylamide compounds, acrylic acid compounds, methacrylic acid compounds. In some cases, monomer compounds may include hydrophobic groups. In some cases, monomer compounds may include functional groups, such as an azido functional group, an alkyne functional group (e.g., for Click chemistry), an amine functional group, a carboxyl functional group, an ester functional group, an activated carboxyl functional group, a toluenesulfonyl (tosyl) functional group, an aldehyde functional group, or a thiol functional group. In some cases, monomer compounds may include protecting functional groups, such as a tosyl group, a tert-butoxycarbonyl (BOC) group, a benzyl group, a tert-butyl group, or a trimethoxysilyl group. Specific monomer compounds include, but are not limited to, glycidyl methacrylate, styrene, 2-ethylhexyl methacrylate, hexyl methacrylate, lauryl methacrylate, benzyl methacrylate, cyclohexyl methacrylate, methacrylamide, acrylamide, acrylic acid, methacrylic acid, 2-aminoethylmethacrylamide, azido-PEG4-acrylate, 3-azidopropyl acrylate, N-(5-acrylamidopentyl)-2-(1-azidoethyl) benzamide, N-tosyl-acrylamide, (2-Boc-amino)ethyl methacrylate, N-benzylacrylamide, tert-butyl methacrylate, or 3-(trimethoxysilyl)propyl methacrylate. In some examples, multiple different monomer compounds can be used, such as together or in sequence.

### Polymerization

Several different polymerization techniques can be used with the methods disclosed herein, each described below. Generally, these different polymerization techniques do not require elevated temperature conditions and are distinguished from thermal polymerization or thermal-initiation-based swelling processes, where heat is applied to drive polymerization of monomers. The polymerization processes described herein are capable of causing polymerization of monomers in the monomer drops at room temperature or ambient temperature, such as at a temperature of from 15° C. to 35° C., to form monodisperse polymer beads. In some cases, temperatures outside these ranges can be used with the disclosed polymerization techniques, but it will be appreciated that the techniques described can result in polymerization without being subjected to elevated temperatures. By use of the disclosed polymerization techniques, a size increase from the monosized seed particles to the monodisperse polymer beads of from about 3 to about 6 times can be achieved. For example, in some cases, the monodisperse polymer beads can have a diameter of from about 0.5 μm to about 50 μm. Example diameters for the monodisperse polymer beads can be from 0.5 μm to 1.0 μm, from 1.0 μm to 2.0 μm, from 2.0 μm to 3.0 μm, from 3.0 μm to 4.0 μm, from 4.0 μm to 5.0 μm, from 5.0 μm to 6.0 μm, from 6.0 μm to 7.0 μm, from 7.0 μm to 8.0 μm, from 8.0 μm to 9.0 μm, from 9.0 μm to 10 μm, from 10 μm to 12 μm, from 12 μm to 14 μm, from 14 μm to 16 μm, from 16 μm to 18 μm, from 18 μm to 20 μm, from 20 μm to 25 μm, from 25 μm to 30 μm, from 30 μm to 35 μm, from 35 μm to 40 μm, from 40 μm to 45 μm, or from 45 μm to 50 μm. In some examples, the monodisperse polymer beads can have a CV of 5% or less, 4% or less, 3% or less, 2% or less, or 1% or less.

Various different crosslinking compounds can be used with the disclosed polymerization techniques, such as divinyl compounds, dimethacrylate compounds, vinyl methacyrlate compounds, allyl methacrylate compounds, or vinyl acrylate compounds. Specific example crosslinking compounds include, but are not limited to, ethylene glycol dimethacrylate, divinyl benzene (DVB), 1,4-butanediol divinyl ether, vinyl acrylate, allyl methacrylate, vinyl methacrylate, di(ethylene glycol) divinyl ether, tri(ethylene glycol) divinyl ether, vinyl acrylate, 1,4-butanediol dimethacrylate, 1,6-hexanediol dimethacrylate, or poly(propylene glycol) dimethacrylate. In some examples, multiple different crosslinking compounds can be used, such as together or in sequence.

Various different catalysts can be used with the disclosed polymerization techniques, such as photopolymerization catalysts, atom transfer radical polymerization catalysts, and redox polymerization catalysts. Example photopolymerization catalysts include, but are not limited to, 2-ethylhexyl-4-(dimethylamino)benzoate. Classes of useful atom transfer radical polymerization catalysts include, but are not limited to, fluorescein compounds, phenothiazine compounds, perylene compounds, phenoxazine compounds, phenazine compounds, or phenoxazine compounds. Specific atom transfer radical polymerization catalysts include, but are not limited to, fluorescein, eosin Y, erythrosin B, a phenothiazine, perylene, 10-phenylphenothiazine, naphthyl-phenothiazine, benzo-phenothiazine, 1,2,3,5-tetrakis(carbazol-9-yl)-4,6-dicyanobenzene, s 4-[2-(4-diphenylaminophenyl)thieno[3,2-b]thiophen3-yl]benzonitrile, 3,7-di(2-naphthyl)-2-naphthalene-10-phenoxazine, or derivatives of these. Example redox polymerization catalysts include, but are not limited to N,N-dimethyl-p-toluidine, N,N-dimethylaniline, 2-[4-(dimethylamino)phenyl]ethanol, 2,2′-(4-methylphenylimino)diethanol, N-(4-methoxyphenyl)pyrrolidine, or derivatives of these. In some examples, multiple different catalysts can be used, such as together or in sequence.

### Photopolymerization

In a photopolymerization process, the monomer drops are subjected to ultraviolet light (UV) to initiate polymerization and/or crosslinking of the monomers. As noted above, the photopolymerization process can take place at room temperature. The UV light used for the photopolymerization process can range from about 300 nm to about 400 nm, in some examples. Durations for exposing the monomer drops to UV light for achieving photopolymerization can range from minutes to hours, such as from about 10 minutes to about 2 hours. In some examples, photopolymerization can be achieved in 1 hour or less, depending on the intensity and wavelength of the UV light. In some examples, an initiator compound (e.g., a photoinitiator) can be included or dissolved in a solvent or other activating compound when seed-particles are activated. Optionally, an initiator compound can be added with a monomer compound. Example initiator compounds are described above, which may be used as photoinitiators. Specific initiator compounds used as photoinitiators in the examples below include, 2,2-dimethoxy-2-phenylacetophenone, 2-hydroxy-2-methylpropiophenone, and bezophenone. As noted above, photopolymerization catalysts can be used, and can optionally be mixed with the monomer compounds, emulsions, or added to the monomer drops. In one example, 2-ethylhexyl-4-(dimethylamino)benzoate is used as a catalyst for photopolymerization when benzophenone is used as an initiator. A variety of example schemes are detailed below for preparing polymer beads using photopolymerization (Example 1, Example 2, Example 3, Example 4, Example 5, Example 6, Example 7, Example 12, Example 13, Example 14, Example 15, Example 16, Example 17, Example 18, Example 19, Example 20, Example 21, Example 22, Example 23, and Example 24).

### Atom Transfer Radical Polymerization (ATRP)

In an ATRP process, the monomer drops are mixed with or exposed to a crosslinking compound and/or an initiator compound, and, optionally, a catalyst and subjected to visible light in the range of from about 380 nm to 500 nm to initiate polymerization and/or crosslinking of the monomers. As noted above, the ATRP process can take place at room temperature. Durations for exposing the monomer drops to the light for achieving ATRP can range from minutes to hours, such as from about 10 minutes to about 24 hours. In some examples, ATRP can be achieved in 12 hours or less, depending on the intensity and wavelength of the light, the monomer identity, and the concentration and identity of the crosslinking compound, the initiator, and/or the catalyst, for example. As noted above, ATRP catalysts can be used, which can be mixed with the monomer compounds, emulsions, or added to the monomer drops. In one example, fluorescein is used as a catalyst for ATRP when a halo-compound, such as a bromo-compound, is used as an initiator. Two example schemes are detailed below for preparing polymer beads using ATRP (Example 8 and Example 9).

### Redox Polymerization

In a redox polymerization process, the monomer drops are mixed with or exposed to a crosslinking compound and/or an initiator compound, and, optionally, a catalyst to initiate polymerization and/or crosslinking of the monomers by way of a redox reaction. As noted above, the redox polymerization process can take place at room temperature. In some examples, a redox initiator compound can be included or dissolved in a solvent or other activating compound when seed-particles are activated. Optionally, a redox initiator compound can be added with a monomer compound. Example initiator compounds are described above, which may be used as redox initiators, in some cases. Specific redox initiator compounds can include peroxide compounds, such as benzoyl peroxide, for example. In one example, N,N-dimethyl-p-toluidine is used as a catalyst for redox polymerization when a peroxide compound, such as benzoyl peroxide, is used as an initiator. The initiator compound and the catalyst can be mixed with the monomer drops during the polymerization process, and polymerization can be achieved in hours to days, such as from about 6 hours to about 2 days. In some examples, redox polymerization can be achieved in 24 hours or less, depending on the monomer identity, and the concentration and identity of the crosslinking compound, the initiator, and/or the catalyst, for example. Two example schemes are detailed below for preparing polymer beads using redox polymerization (Example 10 and Example 11).

### Tailoring Density of Polymer Beads

Polymer beads having a relatively low density can be useful for maintaining a uniform or more uniform suspension, such as without precipitation or sedimentation. Conditions where precipitation or sedimentation is present may be undesirable for applications such as single cell sequencing, so generating polymer beads with low density can be desirable. A variety of strategies may be employed for generating polymer beads with relatively lower densities. In some examples, selecting particular monomer compounds, such as low-density monomer compounds, may be useful for generating polymer beads with lower densities. In some examples, selecting particular crosslinking compounds, such as low-density crosslinking compounds, may be useful for generating polymer beads with lower densities. In some examples, both low-density monomer compounds and low-density crosslinking compounds may be used, but either of these may alternatively be used without the other. In some examples, the monodisperse polymer beads can exhibit a specific gravity of from 0.8 to 1.4, with a low-density specific gravity being from 0.8 to 1.05.

As examples, providing glycidyl methacrylate as a monomer compound as the basis for comparison, other lower-density monomer compounds include, but are not limited to, hexyl methacrylate, 2-ethylhexyl methacrylate, lauryl methacrylate, cyclohexyl methacrylate. Thus, by using these monomer compounds instead of glycidyl methacrylate, polymer beads with a relatively lower density can be generated. As another example, providing ethylene glycol dimethacrylate as a crosslinking compound as the basis for comparison, other lower-density crosslinking compounds include, but are not limited to, 1,4-butanediol dimethacrylate, 1,6-hexanediol dimethacrylate, poly(propylene glycol) dimethacrylate, vinyl methacrylate, or allyl methacrylate. Thus, by using these crosslinking compounds instead of ethylene glycol dimethacrylate, polymer beads with a relatively lower density can be generated. Three example schemes are detailed below for tailoring density of polymer beads (Example 17, Example 18, and Example 19).

Polymer Beads with Porous Structures

In some examples, polymer beads or monomer drops can include external porogens, such as composed of toluene, cyclohexanol, or polyethylene glycol. The presence of external porogens, may result in undesirable effects, in some cases, such as where phase separation occurs during polymerization. In addition, extraction steps may be used to remove external porogens after polymerization, increasing processing time and complexity. The use of monomer compounds with hydrophobic moieties, however, can form hydrophobic pockets internal to the polymer beads, with these regions serving as internal porogens. This can avoid extraction processing and provide a more controllable pore introduction process. Examples of monomer compounds with hydrophobic moieties include, but are not limited to, hexyl methacrylate, 2-ethylhexyl methacrylate, lauryl methacrylate, benzyl methacrylate, or cyclohexyl methacrylate. One example scheme is detailed below for preparing polymer beads with internal porogens (Example 20).

### Functionalized Polymer Beads

Functionalized polymer beads may be generated using the methods described herein by using monomer compounds that include the desired functionality. For example, monomer compounds may include functional groups, such as, but not limited to, azido functional groups, alkyne functional groups (e.g., for Click chemistry), amine functional groups, carboxyl functional groups, ester functional groups, or activated carboxyl groups, which can result in the polymer beads also including these functional groups. Such groups can advantageously be used to couple to biomolecules, such as proteins and DNA oligonucleotides. Specific examples of monomer compounds with functional groups include, but are not limited to, methacrylamide, acrylamide, 2-aminoethylmethacrylamide, acrylic acid, methacrylic acid, azido-PEG4-acrylate, 3-azidopropyl acrylate, or N-(5-acrylamidopentyl)-2-(1-azidoethyl) benzamide. Two example schemes are detailed below for preparing functionalized polymer beads (Example 21 and Example 22).

Polymer Beads with Latent Functionality

As an extension of functionalized polymer beads, the use of monomer compounds with specific functional groups including protecting moieties can be used to generate polymer beads with latent functionality according to the disclosed methods. The latent functionality can be accessed, when desired, by exposing the polymer beads to deprotection conditions, which can remove or alter the protecting moieties. For example, monomer compounds may include protecting functional groups, such as, but not limited to, a toluenesulfonyl (tosyl) group, a tert-butoxycarbonyl (BOC) group, a benzyl group, a tert-butyl group, or a trimethoxysilyl group, which can result in the polymer beads also including these protecting functional groups. Deprotection conditions can include, but are not limited to, exposure to acidic conditions (e.g., pH less than 7 or less than 6) or strongly acidic conditions (e.g., pH less than 3), exposure to basic conditions (e.g., pH greater than 7 or greater than 8) or strongly basic conditions (e.g., pH greater than 11), exposure to reducing conditions, exposure to oxidizing conditions, exposure to strong acids (e.g., HF), or the like. Specific example protecting functional groups include, but are not limited to, N-tosyl-acrylamide, (2-butoxycarbonyl-amino)ethyl methacrylate, N-benzylacrylamide, tert-butyl methacrylate, 3-(trimethoxysilyl)propyl methacrylate. Two example schemes are detailed below for preparing protected functionalized polymer beads (Example 23 and Example 24).

Aspects of the invention may be further understood by reference to the following non-limiting examples.

### Example 1: 5 μm Seeds, DMPA in Toluene as Initiator, Glycidyl Methacrylate as Monomer, Ethylene Glycol Dimethacrylate as Crosslinker

0.25 g 2,2-dimethoxy-2-phenylacetophenone (DMPA) was added into 0.25 mL toluene. After 2,2-dimethoxy-2-phenylacetophenone is completely dissolved, this 2,2-dimethoxy-2-phenylacetophenone solution, 48.25 mL water, and 1.25 mL 10% sodium dodecyl sulfate (SDS) solution were homogenized to an emulsion. 0.25 g monodisperse polystyrene particles with a diameter of 5 μm was added to this emulsion. After stirring for 24 h, the latex was transferred to a reactor containing 20 g of glycidyl methacrylate and 1 g of ethylene glycol dimethacrylate. After stirring for 4 h, the suspension was exposed under 365 nm UV light for 1 h. A monodisperse latex with a diameter of 15 μm was obtained.

### Example 2: 5 μm Seeds, DMPA in 1-Chlorododecane as Initiator; Glycidyl Methacrylate as Monomer, Ethylene Glycol Dimethacrylate as Crosslinker

2,2-dimethoxy-2-phenylacetophenone was dissolved in 1-chlorododecane to make a saturated solution. 0.5 mL of this 2,2-dimethoxy-2-phenylacetophenone solution, 48.25 mL water, and 1.25 mL 10% SDS solution were homogenized to an emulsion. 0.25 g monodisperse polystyrene particles with a diameter of 5 μm was added to this emulsion. After stirring for 24 h, the latex was transferred to a reactor containing 20 g of glycidyl methacrylate and 1 g of ethylene glycol dimethacrylate. After stirring for 4 h, the suspension was exposed under 365 nm UV light for 1 h. A monodisperse latex with a diameter of 15 μm was obtained.

### Example 3: 5 μm Seeds, Benzophenone in Toluene Plus EHDEB as Initiator; Glycidyl Methacrylate as Monomer, Ethylene Glycol Dimethacrylate as Crosslinker

Benzophenone was dissolved in toluene to make a saturated solution. 0.5 mL of this benzophenone solution, 100 μL of 2-ethylhexyl 4-(dimethylamino)benzoate (EHDEB), 48.25 mL water, and 1.2 5 mL 10% SDS solution were homogenized to an emulsion. 0.25 g monodisperse polystyrene particles with a diameter of 5 μm was added to this emulsion. After stirring for 24 h, the latex was transferred to a reactor containing 20 g of glycidyl methacrylate and 1 g of ethylene glycol dimethacrylate. After stirring for 4 h, the suspension was exposed under 365 nm UV light for 1 h. A monodisperse latex with a diameter of 15 μm was obtained.

### Example 4: 5 μm Seeds, 1-Chlorododecane as Activator; 3% DMPA as Initiator in Monomer Mixture of Glycidyl Methacrylate and Ethylene Glycol Dimethacrylate

0.5 mL of 1-chlorododecane, 48.25 mL water, and 1.25 mL 10% SDS solution were homogenized to an emulsion. 0.25 g monodisperse polystyrene particles with a diameter of 5 μm was added to this emulsion. After carefully stirring for 24 h, the latex was transferred to a reactor containing 0.6 g of 2,2-dimethoxy-2-phenylacetophenone, 20 g of glycidyl methacrylate, and 1 g of ethylene glycol dimethacrylate. After stirring for 4 h, the suspension was exposed under 365 nm UV light for 1 h. A monodisperse latex with a diameter of 15 μm was obtained. A micrograph image of a plurality of individual beads is shown in FIG. 2.

### Example 5: 5 μm Seeds, 1-Chlorododecane as Activator; 3% HMP as Initiator in Monomer Mixture of Glycidyl Methacrylate and Ethylene Glycol Dimethacrylate

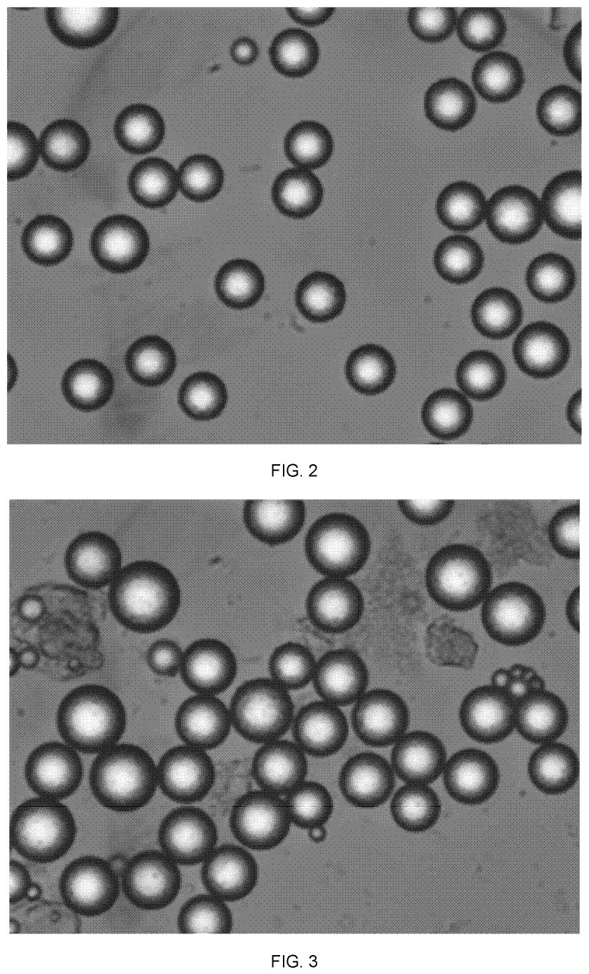

0.5 mL of 1-chlorododecane, 48.25 mL, water, and 1.25 mL 10% SDS solution were homogenized to an emulsion. 0.25 g monodisperse polystyrene particles with a diameter of 5 μm was added to this emulsion. After carefully stirring for 24 h, the latex was transferred to a reactor containing 0.6 g of 2-hydroxy-2-methylpropiophenone (HMP), 20 g of glycidyl methacrylate, and 1 g of ethylene glycol dimethacrylate. After stirring for 4 h, the suspension was exposed under 365 nm UV light for 1 h. A monodisperse latex with a diameter of 15 μm was obtained. A micrograph image of a plurality of individual beads is shown in FIG. 3.

### Example 6: 5 μm Seeds, 1-Chlorododecane as Activator; 3% DMPA as Initiator in Monomer Mixture of 2-Ethylhexyl Methacrylate and Ethylene Glycol Dimethacrylate

0.5 mL of 1-chlorododecane, 48.25 mL water, and 1.25 mL 10% SDS solution were homogenized to an emulsion. 0.25 g monodisperse polystyrene particles with a diameter of 5 μm was added to this emulsion. After carefully stirring for 24 h, the latex was transferred to a reactor containing 0.6 g of 2,2-dimethoxy-2-phenylacetophenone, 20 g of 2-ethylhexyl methacrylate, and 1 g of ethylene glycol dimethacrylate. After stirring for 4 h, the suspension was exposed under 365 nm UV light for 1 h. A monodisperse latex with a diameter of 15 μm was obtained.

### Example 7: 5 μm Seeds, 1-Chlorododecane as Activator, 3% DMPA as Initiator in Monomer Mixture of Styrene and DVB

0.5 mL of 1-chlorododecane, 48.25 mL water, and 1.25 mL 10% SDS solution were homogenized to an emulsion. 0.25 g monodisperse polystyrene particles with a diameter of 5 μm was added to this emulsion. After carefully stirring for 24 h, the latex was transferred to a reactor containing 0.6 g of 2,2-dimethoxy-2-phenylacetophenone, 20 g of Styrene, and 1 g of divinylbenzene (DVB). After stirring for 4 h, the suspension was exposed under 365 nm UV light for 1 h. A monodisperse latex with a diameter of 15 μm was obtained.

### Example 8: 5 μm Seeds, EBPA as Initiator; after Monomer Swelling, Add Fluorescein (Dissolved in Dimethylsulfoxide (DMSO))

0.5 mL of ethyl α-bromophenylacetate (EBPA), 48.25 mL water, and 1.25 mL 10% SDS solution were homogenized to an emulsion. 0.25 g monodisperse polystyrene particles with a diameter of 5 μm was added to this emulsion. After carefully stirring for 24 h, the latex was transferred to a reactor containing 20 g of glycidyl methacrylate and 1 g of ethylene glycol dimethacrylate. After stirring for 4 h, 1 mg of fluorescein was added to the suspension, and the mixture was exposed under 450 nm light for 10 h. A monodisperse latex with a particle diameter of 15 μm was obtained.

### Example 9: 5 μm Seeds, CD as Activator, EBPA as Initiator in Monomer Mixture. After Swelling, Add Fluorescein (Dissolved in DMSO)

0.5 mL of 1-chlorododecane, 48.25 mL, water, and 1.25 mL 10% SDS solution were homogenized to an emulsion. 0.25 g monodisperse polystyrene particles with a diameter of 5 μm was added to this emulsion. After stirring for 24 h, the latex was transferred to a reactor containing 0.6 g of ethyl α-bromophenylacetate, 20 g of glycidyl methacrylate, and 1 g of ethylene glycol dimethacrylate. After stirring for 4 h, 1 mg of fluorescein was added to the suspension, and the mixture was exposed under 450 nm light for 10 h. A monodisperse latex with a particle diameter of 10 μm was obtained.

Example 10: 5 μm Seeds, Benzoyl Peroxide in Toluene as Initiator; Glycidyl Methacrylate as Monomer, Ethylene Glycol Dimethacrylate as Crosslinker. After Swelling, Add N,N-Dimethyl-p-Toluidine to Initiate Polymerization

Benzoyl peroxide (BPO) was dissolved in toluene to make a saturated solution. 0.5 mL of this benzoyl peroxide solution, 48.25 mL water, and 1.25 mL 10% SDS solution were homogenized to an emulsion. 0.25 g monodisperse polystyrene particles with a diameter of 5 μm was added to this emulsion. After stirring for 24 h, the latex was transferred to a reactor containing 20 g of glycidyl methacrylate and 1 g of ethylene glycol dimethacrylate. After stirring for 4 h, 10 μL of N,N-dimethyl-p-toluidine (DMPT) was added to the suspension, and the mixture was further stirred for 24 h. A monodisperse latex with a particle diameter of 15 μm was obtained.

### Example 11: 5 μm Seeds, 1-Chlorododecane as Activator, 3% BPO as Initiator in Monomer Mixture. After Swelling, Add DMPT for Polymerization

0.5 mL of 1-chlorododecane, 48.25 mL water, and 1.25 mL 10% SDS solution were homogenized to an emulsion. 0.25 g monodisperse polystyrene particles with a diameter of 5 μm was added to this emulsion. After carefully stirring for 24 h, the latex was transferred to a reactor containing 0.6 g of benzoyl peroxide, 20 g of glycidyl methacrylate, and 1 g of ethylene glycol dimethacrylate. After stirring for 4 h, 10 μL of N,N-dimethyl-p-toluidine was added to the suspension, and the mixture was further stirred for 24 h. A monodisperse latex with a particle diameter of 15 μm was obtained.

### Example 12: 0.5 μm Seeds, 1-Chlorododecane as Activator, 3% DMPA as Initiator in Monomer Mixture

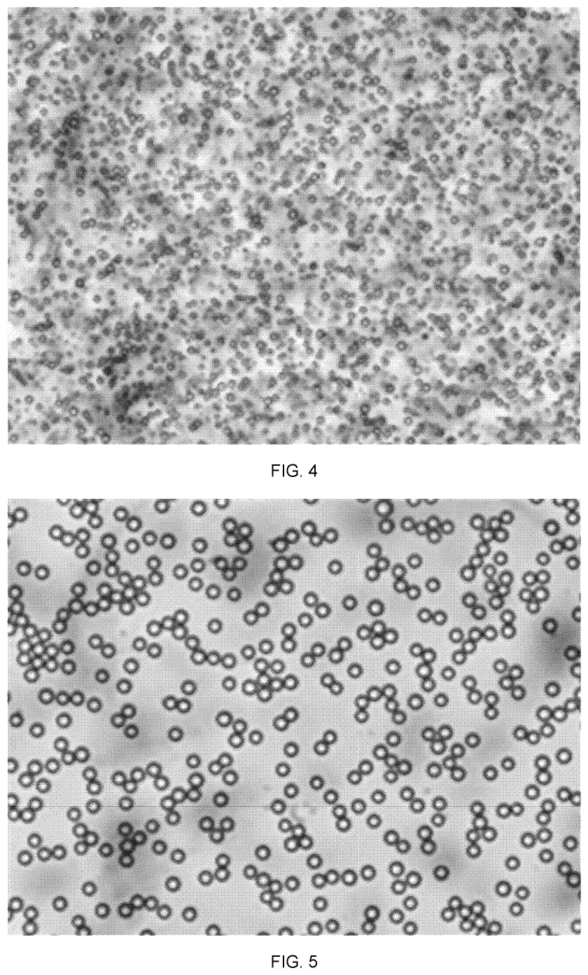

0.5 mL of 1-chlorododecane, 48.25 mL water, and 1.25 mL 10% SDS solution were homogenized to an emulsion. 0.25 g monodisperse polystyrene particles with a diameter of 0.5 μm was added to this emulsion. After carefully stirring for 24 h, the latex was transferred to a reactor containing 0.6 g of 2,2-dimethoxy-2-phenylacetophenone, 35 g of glycidyl methacrylate, and 1.75 g of ethylene glycol dimethacrylate. After stirring for 4 h, the suspension was exposed under 365 nm UV light for 1 h. A monodisperse latex with a diameter of 3 μm was obtained. A micrograph image of a plurality of individual beads is shown in FIG. 4.

### Example 13: 1 μm Seeds, 1-Chlorododecane as Activator, 3% DMPA as Initiator in Monomer Mixture

0.5 mL of 1-chlorododecane, 48.25 mL water, and 1.25 mL 10% SDS solution were homogenized to an emulsion. 0.25 g monodisperse polystyrene particles with a diameter of 1 μm was added to this emulsion. After carefully stirring for 24 h, the latex was transferred to a reactor containing 0.6 g of 2,2-dimethoxy-2-phenylacetophenone, 35 g of glycidyl methacrylate, and 1.75 g of ethylene glycol dimethacrylate. After stirring for 4 h, the suspension was exposed under 365 nm UV light for 1 h. A monodisperse latex with a diameter of 5 μm was obtained. A micrograph image of a plurality of individual beads is shown in FIG. 5.

### Example 14: 2 μm Seeds, 1-Chlorododecane as Activator, 3% DMPA as Initiator in Monomer Mixture

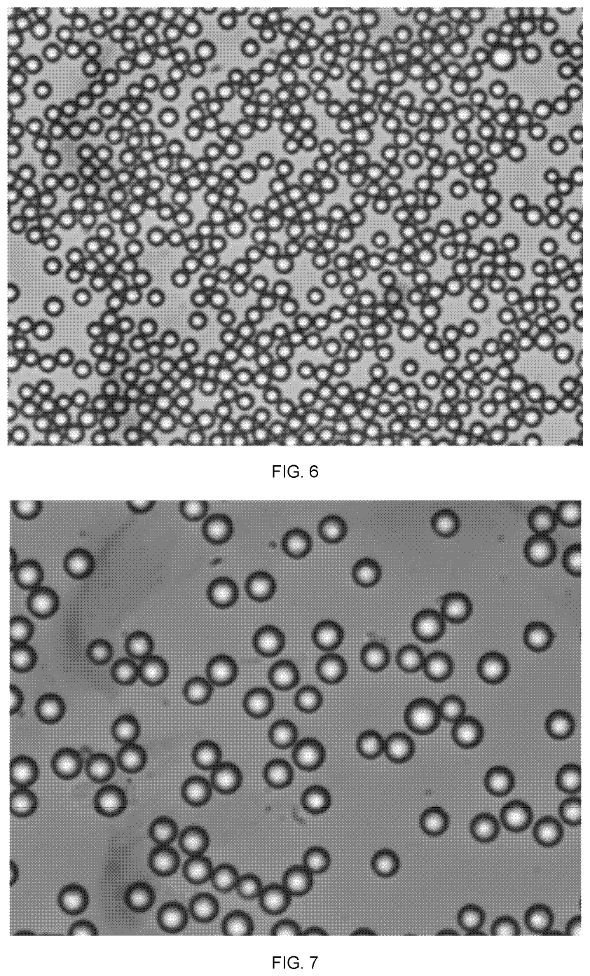

0.5 mL of 1-chlorododecane, 48.25 mL water, and 1.25 mL 10% SDS solution were homogenized to an emulsion. 0.25 g monodisperse polystyrene particles with a diameter of 2 μm was added to this emulsion. After carefully stirring for 24 h, the latex was transferred to a reactor containing 0.6 g of 2,2-dimethoxy-2-phenylacetophenone, 35 g of glycidyl methacrylate, and 1.75 g of ethylene glycol dimethacrylate. After stirring for 4 h, the suspension was exposed under 365 nm UV light for 1 h. A monodisperse latex with a diameter of 7 μm was obtained. A micrograph image of a plurality of individual beads is shown in FIG. 6.

### Example 15: 3 μm Seeds, 1-Chlorododecane as Activator, 3% DMPA as Initiator in Monomer Mixture

0.5 mL of 1-chlorododecane, 48.25 mL water, 1.25 mL 10% SDS solution were homogenized to an emulsion. 0.25 g monodisperse polystyrene particles with a diameter of 3 μm was added to this emulsion. After carefully stirring for 24 h, the latex was transferred to a reactor containing 0.6 g of 2,2-dimethoxy-2-phenylacetophenone, 20 g of glycidyl methacrylate, and 1 g of ethylene glycol dimethacrylate. After stirring for 4 h, the suspension was exposed under 365 nm UV light for 1 h. A monodisperse latex with a diameter of 10 μm was obtained. A micrograph image of a plurality of individual beads is shown in FIG. 7.

### Example 16: 10 μm Seeds, 1-Chlorododecane as Activator, 3% DMPA as Initiator in Monomer Mixture

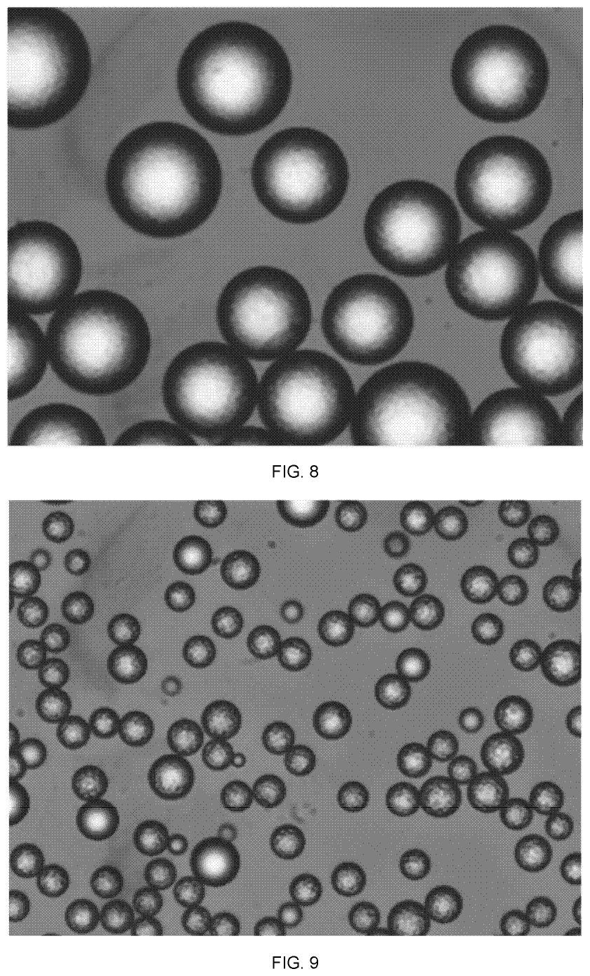

0.5 mL of 1-chlorododecane, 48.25 mL water, and 1.25 mL 10% SDS solution were homogenized to an emulsion. 0.25 g monodisperse polystyrene particles with a diameter of 10 μm was added to this emulsion. After carefully stirring for 24 h, the latex was transferred to a reactor containing 0.6 g of 2,2-dimethoxy-2-phenylacetophenone, 20 g of glycidyl methacrylate, and 1 g of ethylene glycol dimethacrylate. After stirring for 4 h, the suspension was exposed under 365 nm UV light for 1 h. A monodisperse latex with a diameter of 35 μm was obtained. A micrograph image of a plurality of individual beads is shown in FIG. 8.

### Example 17: 5 μm Seeds, 1-Chlorododecane as Activator, 3% DMPA as Initiator in Monomer Mixture of Glycidyl Methacrylate (25%), Hexyl Methacrylate (75%), and Ethylene Glycol Dimethacrylate

0.5 mL of 1-chlorododecane, 48.25 mL water, and 1.25 mL 10% SDS solution were homogenized to an emulsion. 0.25 g monodisperse polystyrene particles with a diameter of 5 μm was added to this emulsion. After carefully stirring for 24 h, the latex was transferred to a reactor containing 0.6 g of 2,2-dimethoxy-2-phenylacetophenone, 5 g of glycidyl methacrylate, 15 g of hexyl methacrylate, and 1 g of ethylene glycol dimethacrylate. After stirring for 4 h, the suspension was exposed under 365 nm UV light for 1 h. A monodisperse latex with a relatively low density was obtained. A micrograph image of a plurality of individual beads is shown in FIG. 9.

### Example 18: 5 μm Seeds, 1-Chlorododecane as Activator, 3% DMPA as Initiator in Monomer Mixture of Glycidyl Methacrylate and Divinyl Benzene

0.5 mL of 1-chlorododecane, 48.25 mL water, and 1.25 mL 10% SDS solution were homogenized to an emulsion. 0.25 g monodisperse polystyrene particles with a diameter of 5 μm was added to this emulsion. After carefully stirring for 24 h, the latex was transferred to a reactor containing 0.6 g of 2,2-dimethoxy-2-phenylacetophenone, 20 g of glycidyl methacrylate, and 1 g of divinylbenzene. After stirring for 4 h, the suspension was exposed under 365 nm UV light for 1 h. A monodisperse latex with a relatively low density was obtained.

### Example 19: 5 μm Seeds, 1-Chlorododecane as Activator, 3% DMPA as Initiator in Monomer Mixture of Glycidyl Methacrylate (5%), Hexyl Methacrylate (95%), and Divinyl Benzene

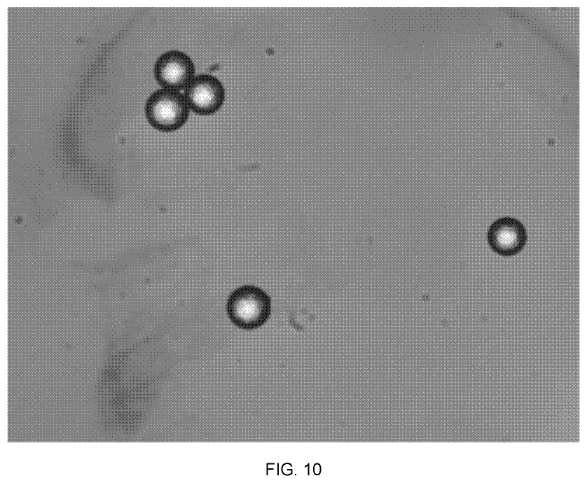

0.5 mL of 1-chlorododecane, 48.25 mL water, and 1.25 mL 10% SDS solution were homogenized to an emulsion. 0.25 g monodisperse polystyrene particles with a diameter of 5 μm was added to this emulsion. After carefully stirring for 24 h, the latex was transferred to a reactor containing 0.6 g of 2,2-dimethoxy-2-phenylacetophenone, 1 g of glycidyl methacrylate, 19 g of hexyl methacrylate, and 1 g of divinylbenzene. After stirring for 4 h, the suspension was exposed under 365 nm UV light for 1 h. A monodisperse latex with a lower density was obtained. A micrograph image of a plurality of individual beads is shown in FIG. 10.

### Example 20: 5 μm Seeds, 1-Chlorododecane as Activator, 3% DMPA as Initiator in Monomer Mixture of Glycidyl Methacrylate (5%), Benzyl Methacrylate (95%), and Divinyl Benzene

0.5 mL of 1-chlorododecane, 48.25 mL water, and 1.25 mL 10% SDS solution were homogenized to an emulsion. 0.25 g monodisperse polystyrene particles with a diameter of 5 μm was added to this emulsion. After carefully stirring for 24 h, the latex was transferred to a reactor containing 0.6 g of 2,2-dimethoxy-2-phenylacetophenone, 1 g of glycidyl methacrylate, 19 g of Benzyl methacrylate, and 1 g of divinylbenzene. After stirring for 4 h, the suspension was exposed under 365 nm UV light for 1 h. A monodisperse latex with a diameter of 15 μm was obtained.

### Example 21: 5 μm Seeds, 1-Chlorododecane as Activator, 3% DMPA as Initiator in Monomer Mixture of Glycidyl Methacrylate, Methacrylamide, and Ethylene Glycol Dimethacrylate

0.5 mL of 1-chlorododecane, 48.25 mL water, and 1.25 mL 10% SDS solution were homogenized to an emulsion. 0.25 g monodisperse polystyrene particles with a diameter of 5 μm was added to this emulsion. After carefully stirring for 24 h, the latex was transferred to a reactor containing 0.6 g of 2,2-dimethoxy-2-phenylacetophenone, 19 g of glycidyl methacrylate, 1 g of Methacrylamide, and 1 g of ethylene glycol dimethacrylate. After stirring for 4 h, the suspension was exposed under 365 nm UV light for 1 h. A monodisperse latex functionalized with amine groups was obtained.

### Example 22: 5 μm Seeds, 1-Chlorododecane as Activator, 3% DMPA as Initiator in Monomer Mixture of Glycidyl Methacrylate, 3-Azidopropyl Acrylate, and Ethylene Glycol Dimethacrylate

0.5 mL of 1-chlorododecane, 48.25 mL water, and 1.25 mL 10% SDS solution were homogenized to an emulsion. 0.25 g monodisperse polystyrene particles with a diameter of 5 μm was added to this emulsion. After carefully stirring for 24 h, the latex was transferred to a reactor containing 0.6 g of 2,2-dimethoxy-2-phenylacetophenone, 19 g of glycidyl methacrylate, 1 g of 3-Azidopropyl acrylate, and 1 g of ethylene glycol dimethacrylate. After stirring for 4 h, the suspension was exposed under 365 nm UV light for 1 h. A monodisperse latex functionalized with azido groups was obtained.

### Example 23: 5 μm Seeds, 1-Chlorododecane as Activator, 3% DMPA as Initiator in Monomer Mixture of Glycidyl Methacrylate, N-Tosyl-Acrylamide, and Ethylene Glycol Dimethacrylate

0.5 mL of 1-chlorododecane, 48.25 mL water, and 1.25 mL 10% SDS solution were homogenized to an emulsion. 0.25 g monodisperse polystyrene particles with a diameter of 5 μm was added to this emulsion. After carefully stirring for 24 h, the latex was transferred to a reactor containing 0.6 g of 2,2-dimethoxy-2-phenylacetophenone, 19 g of glycidyl methacrylate, 1 g of N-tosyl-acrylamide, and 1 g of ethylene glycol dimethacrylate. After stirring for 4 h, the suspension was exposed under 365 nm UV light for 1 h. A monodisperse latex functionalized with tosyl protected amine groups was obtained.

### Example 24: 5 μm Seeds, 1-Chlorododecane as Activator, 3% DMPA as Initiator in Monomer Mixture of Glycidyl Methacrylate, 3-(Trimethoxysilyl)Propyl Methacrylate, and Ethylene Glycol Dimethacrylate

0.5 mL of 1-chlorododecane, 48.25 mL water, and 1.25 mL 10% SDS solution were homogenized to an emulsion. 0.25 g monodisperse polystyrene particles with a diameter of 5 μm was added to this emulsion. After carefully stirring for 24 h, the latex was transferred to a reactor containing 0.6 g of 2,2-dimethoxy-2-phenylacetophenone, 19 g of glycidyl methacrylate, 1 g of 3-(Trimethoxysilyl)propyl methacrylate, and 1 g of ethylene glycol dimethacrylate. After stirring for 4 h, the suspension was exposed under 365 nm UV light for 1 h. A monodisperse latex functionalized with silyl protected carboxyl groups was obtained.

### STATEMENTS REGARDING INCORPORATION BY REFERENCE AND VARIATIONS

All references throughout this disclosure, for example patent documents including issued or granted patents or equivalents, patent application publications, and non-patent literature documents or other source material, are hereby incorporated by reference herein in their entireties, as though individually incorporated by reference.

All patents and publications mentioned in this disclosure are indicative of the levels of skill of those skilled in the art to which the invention pertains. References cited herein are incorporated by reference herein in their entirety to indicate the state of the art, in some cases as of their filing date, and it is intended that this information can be employed herein, if needed, to exclude (for example, to disclaim) specific embodiments that are in the prior art. For example, when a compound is claimed, it should be understood that compounds known in the prior art, including certain compounds disclosed in the references disclosed herein (particularly in referenced patent documents), are not intended to be included in the claim.

When a group of substituents is disclosed herein, it is understood that all individual members of those groups and all subgroups and classes that can be formed using the substituents are disclosed separately. When a Markush group or other grouping is used herein, all individual members of the group and all combinations and subcombinations possible of the group are intended to be individually included in the disclosure. As used herein, “and/or” means that one, all, or any combination of items in a list separated by “and/or” are included in the list; for example “1, 2 and/or 3” is equivalent to “‘1’, ‘2’, ‘3’, ‘1 and 2’, ‘1 and 3’, ‘2 and 3’, or ‘1, 2, and 3’”.

Every formulation or combination of components described or exemplified can be used to practice the invention, unless otherwise stated. Specific names of materials are intended to be exemplary, as it is known that one of skill in the art can name the same material differently. It will be appreciated that methods, device elements, starting materials, and synthetic methods other than those specifically exemplified can be employed in the practice of the invention without resort to undue experimentation. All art-known functional equivalents, of any such methods, device elements, starting materials, and synthetic methods are intended to be included in this disclosure. Whenever a range is given in the specification, for example, a temperature range, a time range, or a composition range, all intermediate ranges and subranges, as well as all individual values included in the ranges given are intended to be included in the disclosure.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising,” particularly in a description of components of a composition or in a description of elements of a device, is understood to encompass those compositions and methods consisting essentially of and consisting of the recited components or elements. The aspects illustratively described herein suitably may be practiced in the absence of any element or elements, limitation or limitations which is not specifically disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present disclosure describes various embodiments and optional features, modification and variation of the concepts disclosed herein may be resorted to by those skilled in the art, and that such modifications and variations are considered to be within the scope of this invention as defined by the appended claims.

1. A method comprising:
mixing monosized polystyrene seed particles with an activating compound to generate activated seed particles;
mixing the activated seed particles with a monomer compound and a crosslinking compound to generate monosized monomer drops; and
subjecting the monosized monomer drops to polymerization conditions to generate monodisperse polymer beads, wherein the polymerization conditions comprise a temperature of from 10° ° C. to 40° C.

2. The method of claim 1, wherein mixing the monosized polystyrene seed particles with the activating compound occurs at a temperature of from 10° C. to 40° C.

3. The method of claim 1, wherein mixing the activated seed particles with the monomer compound and the crosslinking compound occurs at a temperature of from 10° ° C. to 40° C.

4. The method of claim 1, wherein the monodisperse polymer beads exhibit a coefficient of variation (CV) of 5% or less, wherein the monosized polystyrene seed particles have a diameter selected from 0.1 μm to 20 μm, wherein the monodisperse polymer beads have a diameter selected from 0.5 μm to 50 μm, wherein the monodisperse polymer beads have a diameter of from 3 to 6 times a diameter of the monosized polystyrene seed particles, or wherein the monodisperse polymer beads exhibit a specific gravity of from 0.8 to 1.4 or from 0.8 to 1.05.

5-8. (canceled)

9. The method of claim 1, wherein the activating compound is present in an emulsion, or wherein mixing the monosized polystyrene seed particles with the activating compound comprises forming an aqueous emulsion of the activated seed particles.

10-11. (canceled)

12. The method of claim 1, wherein the activating compound is an initiator compound, the initiator compound containing a benzoyl group, a phenyl acetyl group, or comprising a Norish type I or type II photoinitiator, a redox initiator, or an atom transfer radical polymerization (ATRP) initiator, or wherein the activating compound comprises a benzoin compound or a benzoin derivative, an acetophenone compound or an acetophenone derivative, a benzilketal compound, an α-hydroxyalkylphenone compound, an α-aminoalkylphenone compound, an O-acyl α-oximinoketone compound, an acylphosphine oxide compound, an acylphosphonate compound, a bromo compound, or a peroxide compound.

13-15. (canceled)

16. The method of claim 1, wherein the monomer compound is a vinyl monomer, an acrylate monomer, a methacrylate monomer, a methacrylamide compound, an acrylamide compound, an acrylic acid compound, or a methacrylic acid compound.

17. (canceled)

18. The method of claim 1, wherein the monodisperse polymer beads comprise porous polymer beads including one or more porogens.

19. (canceled)

20. The method of claim 1, wherein the monomer compound comprises a functional group and wherein the monodisperse polymer beads comprise functionalized polymer beads.

21. (canceled)

22. The method of claim 1, wherein the monomer compound comprises a protecting functional group and wherein the monodisperse polymer beads comprise polymer beads with latent functionality.

23-24. (canceled)

25. The method of claim 1, wherein the crosslinking compound is a divinyl compound, a dimethacrylate compound, a vinyl methacyrlate compound, an allyl methacrylate compound, or a vinyl acrylate compound.

26. (canceled)

27. The method of claim 1, wherein mixing the activated seed particles comprises mixing the activated seed particles with the monomer compound, the crosslinking compound, and an initiator compound.

28. The method of claim 27, wherein the initiator compound contains a benzoyl group, a phenyl acetyl group, or comprises a Norish type I or type II photoinitiator, a redox initiator, or an atom transfer radical polymerization (ATRP) initiator, or wherein the initiator compound comprises a benzoin compound or a benzoin derivative, an acetophenone compound or an acetophenone derivative, a benzilketal compound, an α-hydroxyalkylphenone compound, an α-aminoalkylphenone compound, an O-acyl α-oximinoketone compound, an acylphosphine oxide compound, an acylphosphonate compound, a bromo compound, or a peroxide compound.

29-30. (canceled)

31. The method of claim 1, wherein the polymerization conditions comprise exposing the monosized monomer drops to ultraviolet light.

32. The method of claim 1, wherein the polymerization conditions comprise mixing the monosized monomer drops with a catalyst and exposing to ultraviolet light.

33. The method of claim 32, wherein mixing the activated seed particles comprises mixing the activated seed particles with the monomer compound, the crosslinking compound, and an initiator compound, wherein the initiator compound is benzophenone, and wherein the catalyst is 2-ethylhexyl-4-(dimethylamino)benzoate.

34. The method of claim 1, wherein the polymerization conditions comprise mixing the monosized monomer drops with a catalyst and exposing to light having a wavelength of from 380 nm to 500 nm.

35. The method of claim 34, wherein the catalyst is an atom transfer radical polymerization (ATRP) photocatalyst, or wherein the catalyst is a fluorescein compound, a phenothiazine compound, a perylene compound, a phenoxazine compound, a phenazine compound, or phenoxazine compound.

36-37. (canceled)

38. The method of claim 1, wherein the polymerization conditions comprise mixing the monosized monomer drops with a redox catalyst.

39. (canceled)

40. The method of claim 1, further comprising magnetizing the monodisperse polymer beads or attaching a nucleic acid sequence or bio-conjugate to the monodisperse polymer beads.

41-42. (canceled)
